(19) United States
(12) Patent Application Publication
(10) Pub. No.: US 2017/0076015 A1
(43) Pub. Date: Mar. 16, 2017

(54) METHOD FOR DEPLOYING SENSORS

(71) Applicant: PHILIPS LIGHTING HOLDING B.V., EINDHOVEN (NL)

(72) Inventors: MAULIN DAHYABHAI PATEL, EINDHOVEN (NL); JIA HU, EINDHOVEN (NL); YUN GU, EINDHOVEN (NL)

(21) Appl. No.: 15/122,910

(22) PCT Filed: Feb. 19, 2015
(86) PCT No.: PCT/IB2015/051276

§ 371 Date: Aug. 31, 2016

Related U.S. Application Data
(60) Provisional application No. 62/105,242, filed on Jan. 20, 2015.
(60) Provisional application No. 61/947,025, filed on Mar. 3, 2014.

(51) Int. Cl. G06F 17/50

(52) U.S. Cl. CPC G06F 17/5004

(57) ABSTRACT

Methods and apparatus for the sensor deployment. More particularly, a method for deploying sensors in a predefined space, wherein the method uses a building information model (BIM), the method comprising steps of in a processor, receiving, from the BIM, geometry information of a space which relates to a sensing coverage area of the space and sensor information, creating sensor family information defining at least two or more parameters of a respective sensor and information relating to the BIM, transmitting the sensor family information to the BIM, receiving spatial geometry information including elements within the space from the BIM, identifying at least one function of the space using the spatial geometry information, wherein the function of the space is used to identify a sensor from the sensor family information, determining a sensor location in the space for the identified sensor using the sensor family information and spatial geometry information, evaluating whether the identified sensor and/or sensor location for the space satisfies a sensing objective.

This application claims the benefit of U.S. Provisional Patent Application No. 61/947,025, filed Mar. 3, 2014 and U.S. Provisional Patent Application No. 62/105,242, filed Jan. 20, 2015. These applications are hereby incorporated by reference herein.

This application relates to the field of sensor placement and deployment and more particularly to a method and a system for sensor placement and deployment using Building Information Modeling (BIM) software.

Lighting controls and Building Automation Systems are proven methods for improving operational efficiency and occupant comfort. The performance of these systems is heavily influenced by the placement of sensors such as occupancy, photo, temperature, humidity, smoke and CO₂ sensors. Incorrect sensor placement can compromise performance, cause discomfort to the occupants and diminish cost savings. For example, placing a passive infrared (PIR)-based occupancy sensors close to HVAC exhausts can lead to false positive triggers thereby diminishing its efficiency and savings. If an occupancy sensor's detection region continues beyond doors (or windows) then it can cause unwanted triggers leading to energy waste. If an occupancy sensor's line of sight to an occupant is blocked by partitions, then lights may turn-off while occupant is present thereby causing discomfort to the occupant. If the photo-sensor is installed near the window then reflections from outside can cause over-dimming thereby compromising occupant comfort.

Typically, a user, (e.g. an electrical contractor) specifies sensor locations on 2D layout drawings. In many cases, the user requests a sensor placement service from a lighting controls supplier. A typical sensing device used in lighting applications may have a photo-sensor and a motion-sensor placed inside one physical enclosure. The placement of such a device has to comply with guidelines for placing both types of sensors. Currently, sensor placement on the building layout is done manually. The process ma includes:

1. An engineer manually evaluates space characteristics such as size and function (e.g., office, conference room, etc.), and locations of walls, doors, windows, luminaires and HVAC vents.

2. The engineer identifies a suitable sensor for a given space type and manually calculates the coverage area based on ceiling height, walls and partitions in the chosen area.

3. The engineer studies the manufacturer's guidelines for sensor placement from sensor data sheets (e.g., do not place the PIR sensor within 2 meter radius of HVAC exhausts; do not place the photo-sensors within 0.75 times ceiling height.

4. The engineer reviews the code requirements (e.g. CA Title 24) that could impact placement.

5. The engineer identifies suitable locations for sensor placement, adds the sensor and coverage area to 2D floor plans and repeats the process until the target areas are sufficiently covered. Given the complexity of the above process, it is not surprising that very often the sensors are placed incorrectly. Installers and commissioners seldom follow the instructions provided in the datasheet thereby jeopardizing the user satisfaction and diminishing the savings potential of the control system. It is difficult to comply with manufacturer specified deployment guidelines during the deployment process.

Some vendors provide AutoCAD plug-ins with a built-in library of 2D sensor drawings and coverage area patterns. These tools are very primitive and meant only to save time spent on drawing sensors and coverage patterns. The entire process is still manually driven. Since 2D drawings are non-computable, it is not feasible to automate sensor placement using 2D drawings. However, Building Information Models (BIM) provide a collection of computable databases of building components.

BIM is a semantically rich digital representation of physical and functional characteristics of a facility. Building models contain information such as geometry, mechanical and electrical equipment, and material information. Due to proven benefits of the BIM methodology, many countries have mandated the use of BIM for governmental projects (e.g. UK, Denmark, Netherlands and Singapore). In the US there exists a national BIM standard and large institutions such as DOD and GSA have adopted BIM methodology.

Building codes and standards are mandated not only for lighting power density (LPD) and illuminance on a workplane, but the lighting control devices and systems performance. As noted above, BIM for a building contains detailed information such as space geometry, luminaire placement, lighting control system layout, physical properties of products and devices etc.

Hence, there is a need to develop software tools and methodologies to automate the deployment of sensors in building models. Streamlining the process using automated tools can help to reduce the time, efforts and cost of sensor deployment. Develop an efficient and effective sensor location optimization methods to optimize sensor locations given the space geometry and sensor information (e.g., space boundary, sensor coverage shape and area) in building models. Develop tools and methodologies to automate the deployment of sensors in building models, capture the characteristics of the space that are important for lighting sensor deployment; provide a workflow that integrates with other sensor deployment methods; and embed the rules and requirement defined in codes and standards in the BIM tool and is able to guide sensor deployment for lighting control, as well as assess code compliance for the lighting and control design.

Currently, no methods or software are available for automatically and effectively deploy lighting sensor into building models. The current sensor deployment methods have many problems and disadvantages including:

Manually installing sensors in the building model not only suffers from inaccuracy but also is tedious and error-prone.

The lighting designers may not have knowledge of rules governing the placement of the sensors for more advanced sensor types or complicated building space.

There are many different types of sensors available. There is no data exchange standard to regulate sensor specifications. The lack of the sensor specification files makes it difficult to develop a general method of deploying different sensor types.

A sensing device may have multiple types of sensors built-into it. For example, a typical sensing device used in lighting application may have a photo-sensor and a motion-sensor placed inside one physical enclosure. The placement of such a device has to comply with guidelines for placing both types of sensors. For example, a photo-sensor placement guideline typically asks installers to avoid its placement near window and a motion sensor placement guideline typically asks installers to avoid its deployment near HVAC vents. Hence, a sensing device which has a photo-sensor and a motion sensor can neither be placed near window nor it can be placed near HVAC vent. Moreover, the coverage areas of a photo-sensor and a motion-sensor can be different.

Sensors may be placed in a ceiling or a wall. The coverage area of a ceiling-mounted sensor depends on mounting height. In addition, interior partitions in the workspace (e.g. walls and cubicles) also affect sensor positions. All these factors affect the sensor deployment and are not easy to be optimized in the manual deployment.

Each model of a sensor has a unique coverage area and deployment guidelines. Furthermore, these keep changing as new models are introduced in the market and guidelines are revised based on field experience. It is very cumbersome for a designer to follow through the placement guidelines of many different models from many different manufacturers.

Manually checking the compliance to code is very complex and error prone process.

Many sensor deployment methods have been developed by researchers to maximize the sensor coverage area or reduce the number of sensors for non-lighting applications. However, these methods are not specific to lighting sensors, and many of these methods are used for deployment of outdoor sensors with limited or little boundary constraints.

For example, Zou, Yi, and Krishnendu Chakrabarty. “Sensor deployment and target localization based on virtual forces.” INFOCOM 2003. Twenty-Second Annual Joint Conference of the IEEE Computer and Communications. IEEE Societies. Vol. 2. IEEE, 2003 developed virtual force algorithms for deploying sensors; Wang, Y., Hu, C., and Tseng, Y. (2005). “Efficient deployment algorithms for ensuring coverage and connectivity of wireless sensor networks.”, IEEE, 114-121; Chakrabarty, K., Iyengar, S. S., Qi, H., and Cho, E. (2002). “Grid coverage for surveillance and target location in distributed sensor networks.” Computers, IEEE Transactions on, 51(12), 1448-1453. These methods are effective in their application context. However, when these methods are applied to lighting sensors, many problems exist. For example:

The coverage shape of sensors considered in those methods are normally circular. The actual lighting sensors have different coverage shapes (e.g., rectangular or elliptical), which makes the method unsuitable for lighting sensor deployment. Also, the coverage area of lighting sensor is a function of mounting height which is not considered in the previous method.

The sensor coverage shape specified in the above mentioned methods only considered one type of shape. However, the lighting sensors have different coverage shapes. For example, some lighting sensors include photo-sensors and motion-sensors, and the two types of sensors have different coverage shapes.

These methods do not consider all the constraints related to lighting sensors. For example, some sensors are required to keep a minimum distance from window or door; some have to face the window within a specified range; some can be placed in ceiling while others have to be mounted on the wall.

A lighting sensor may be placed in ceiling or wall and many of existing methods cannot effectively handle complex obstacles (interior partitions or interior walls) which are common in building models.

Moreover, known methods are not integrated with the building design process or building models.

The spatial information was simplified in these methods. For example, these methods do not consider all the constraints or rules that govern the deployment of lighting sensors. For example, some lighting sensors are required to keep a minimum distance from window or door. Interior furniture and desk is normally not considered in prior art. Lighting sensors may be affected by more complex interior walls and partitions. For example, virtual force method considers simple rectangular “preferred” and “obstacle” areas.

There exist lighting design software tools which also support code compliance functions, for example: Conover, D., “Method and apparatus for automatically determining compliance with building regulations”, US 20090125283 A1; AGi32, Lighting Analysts illumination engineering software, http://www.agi32.com/. However, these are standalone application specific software which are not part of BIM suit. US 20090125283 A1 is limited to determining compliance with building regulations only. It does not check for compliance with lighting and lighting control regulations. AGi32 is able to check whether lighting design meet the code requirement, e.g. lighting power density, average workplane illuminance, and uniformity of the lights. The software calculates the availability of exterior light and compares against several US and international standards. But it doesn't include the details of lighting control system design and control device information. Manual code compliance of lighting control system is labour intensive. None of the existing software tools support code compliance functions for lighting control systems able of providing code compliance of the control system. There is no tool providing guidance according to codes and standards to automate or facilitate lighting designers and engineers to select and deploy sensors related to lighting controls.

The present disclosure is directed to inventive methods and apparatus for the sensor deployment. This method can be used with or incorporated into known building design and BIM software (such as Autodesk Revit), devices or systems. The automatic sensor deployment does not require designers to reference datasheets and/or follow placement guidelines. Instead the guidelines are built-into the tool (e.g. software or device).

According to one aspect of the invention, the invention is incorporated/integrated with the BIM model of a building developed by the architect or designer. The user of the tool specifies criteria for sensor placement such as 1) alignment with workstations and furniture layout; 2) compliance to a code or standard; 3) objectives for optimization (e.g., minimize cost, maximize coverage, etc.); 4) Luminaire grouping method (e.g., how many luminaires are controlled by a sensor); and 5) areas to be covered.

The geometry of spaces such as windows, doors, space boundaries and ceiling height are retrieved from the building model. Then, the electrical, mechanical structures, and physical objects that impact sensing performance e.g. luminaires, HVAC vents and windows are identified in building models.

The function of the space guides sensor model selection. The function of a space is identified such as a conference room, a restroom, a corridor, etc.

In another aspect of the invention, the invention retrieves models of sensors of interest from a central repository (e.g., Autodesk's SEEK database or manufacturer's website) or a library of sensor models. These models are made available by sensor manufacturers and have in-built placement rules and sensor geometry information such as sensor type, suitable space (e.g. conference room, private office, restrooms etc.), coverage area (as a function of ceiling height), and mounting location (ceiling or wall mounted).

In another aspect of the invention, based on the space geometry and its function, suitable sensors are identified from a list of available sensor models and subsequently their properties are listed in the parameter definition file. For example, assume all the sensor parameters are stored in a database. In this case an SQL query is issued to select combined photo and motion sensors for private office with a coverage area larger than 100 square feet.

In another aspect of the invention, the rules governing the placement of sensors are read from the sensor model file (e.g., avoid windows and vents). User inputs such as applicable building codes and standards are also considered. The coverage area for each sensor type is calculated based on placement rules such as mounting location (e.g., ceiling height or distance from wall).

In another aspect of the invention, optimal locations for sensor placement are identified by solving an optimization problem subject to many constraints such as 1) sensor functions (e.g., motion detection or photometry), 2) shape of sensor coverage area (square, circle, rectangle, or ellipse), 3) sensor mounting (e.g., wall/ceiling-mounted), 4) minimum and maximum distance from window/door/vent/ceiling, 5) room geometry (e.g., interior partitions, walls) 6) luminaire grouping (e.g. upper limit on luminaries controlled by one sensor), 7) coverage area (e.g. union of coverage area of individual sensors sufficiently covers the target area) and 8) user specified constraints. The sensor placement optimization method has the ability of automatically deploying sensors based on user-defined objectives (minimizing the number of sensors, costs, maximizing system performance and/or no more than 10% of area is left uncovered, etc.).

The performance of the derived solution is simulated and, compliance with code and performance requirements is checked. If the solution is found non-compliant then the process can evaluate alternative solutions. The most suitable sensor placement solution is selected and sensors locations are provided, for example, inserted in the BIM. The location and true coverage area of each sensor is shown on the floor plan wherein the coverage area is bounded by walls and other physical structures.

According to an aspect of the invention, the sensor deployment method can be optimized for a given objective such as minimizing the total number of sensors deployed, minimizing the total cost of sensor deployed, or optimizing the system performance. For example, if the building design or layout of the furniture is changed then using the tool, the new position of sensors can be quickly determined. According to another aspect of the invention, an automatic code compliance feature can be used in a BIM software to help design a lighting control system that complies with local code, e.g. the location of sensors, based on codes/standards/regulations. It can assist the state/city/town authorities in determining whether the proposed or installed lighting and the control system design meets the requirements specified codes/standards/regulations.

The method can select optimum sensor placement locations by considering: shape of sensor coverage area: square, circle, rectangle, or ellipse; complexity of room geometry: some rooms have “L” or rectangular shape while others have holes in middle of the room, some room has interior partition that could block sensors coverage area; constraints of the sensor deployment: some sensor may have different requirements for the positions (e.g., only ceiling-based, or minimal distance from window).

According to another aspect of the invention, the critical area is defined as an area that a sensor should cover in order to provide good performance. The critical area may include where the desk or cubicles in open plan office is located. This includes optimizing current sensor deployment methods by adding the capabilities of covering preferred areas. The inventive method includes: prioritizing the sensor deployment workflow; optimizing optimum sensor locations by evaluating interior space layout information; and providing coverage of sensors in preferred areas.

According to another aspect of the invention, the method includes embedding building code compliance schema in building information model software by: creating BIM schema of rules and requirements based on codes/standards/regulations in BIM software; creating device and controller family with parameters and information that is related to code compliance; and instructing and supporting lighting control system design to meet codes/standards/regulations requirement including: automatically selecting devices or products; automatically deploying devices or products in the BIM; and assessing code compliance for lighting control design.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well-known devices, circuits, tools, techniques, and methods are omitted so as not to obscure the description of the present system. It should be expressly understood that the drawings are included for illustrative purposes and do not represent the scope of the present system. In the accompanying drawings, like reference numbers in different drawings may designate similar elements. Also, the drawing figures are not necessarily to scale, emphasis instead generally being placed upon illustrating the principles of the invention.

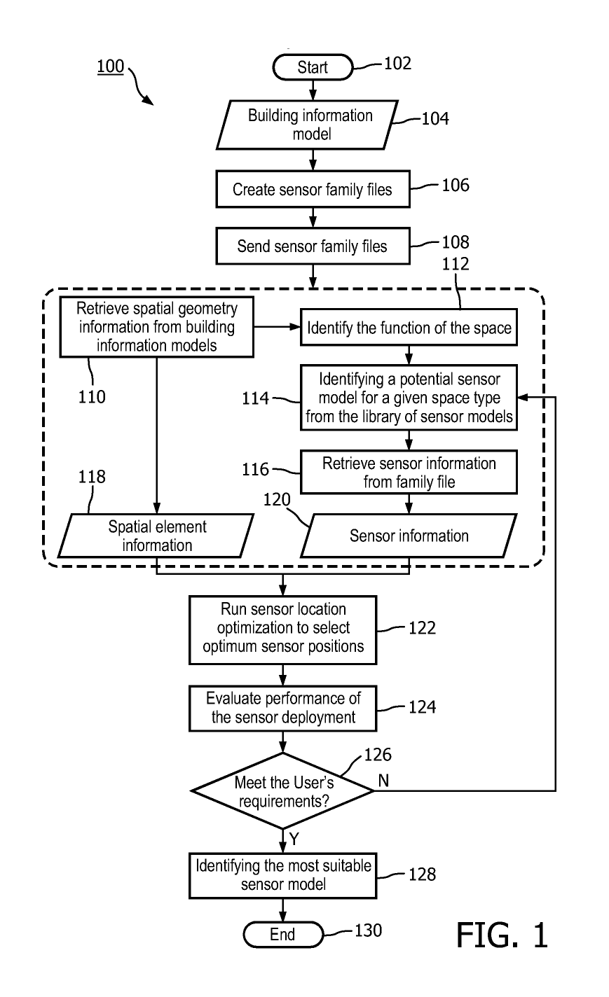

FIG. 1 shows a flow diagram that illustrates a process for sensor deployment in accordance with embodiments of the present system;

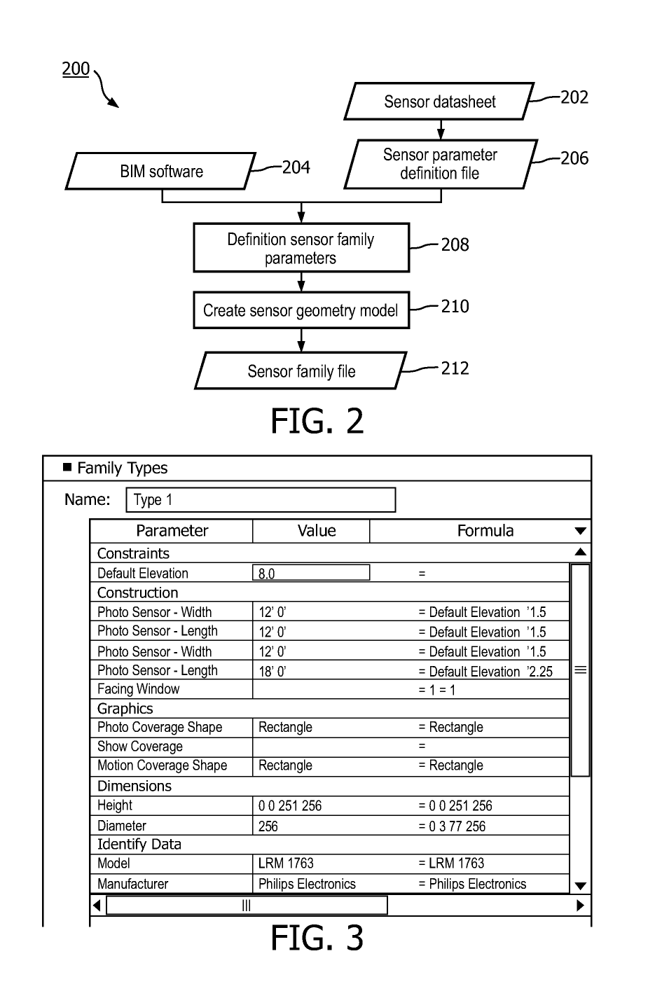

FIG. 2 shows a flow diagram that illustrates process creating sensor family files for process of FIG. 1 in accordance with embodiments of the present system;

FIG. 3 shows a diagram that illustrates a sensor family file;

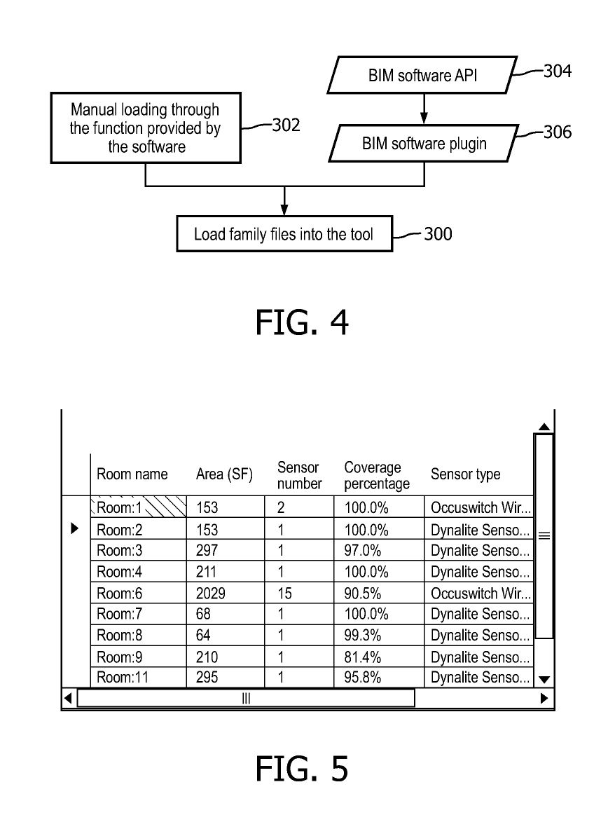

FIG. 4 shows a flow diagram that illustrates process of loading family files into BIM software in accordance with embodiments of the present system;

FIG. 5 shows a diagram that illustrates results of sensor deployment method of FIG. 1;

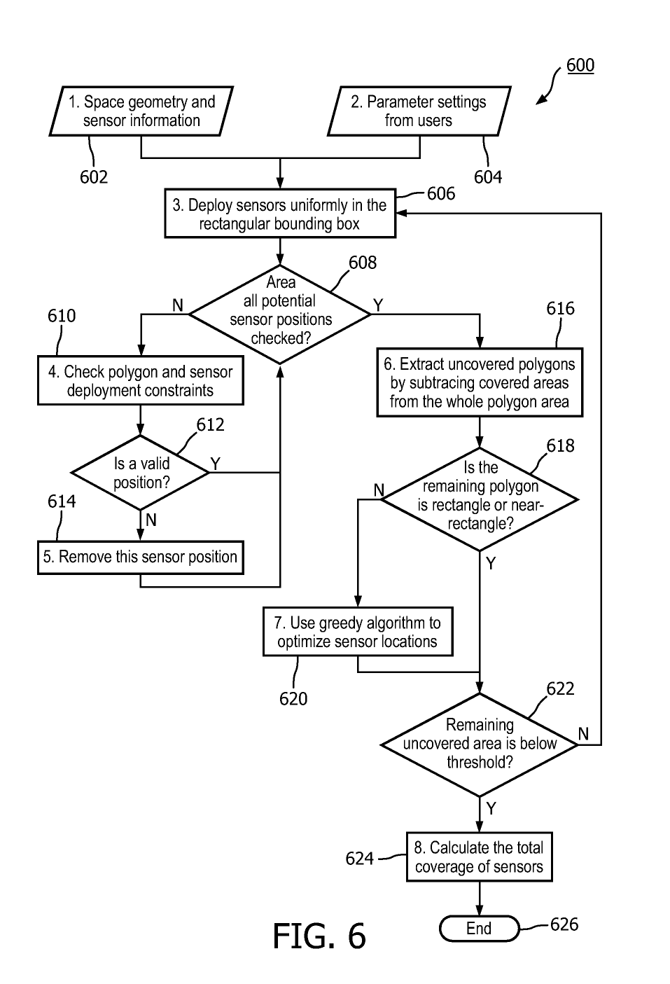

FIG. 6 shows a flow diagram that illustrates a process for sensor location optimization in accordance with embodiments of the present system;

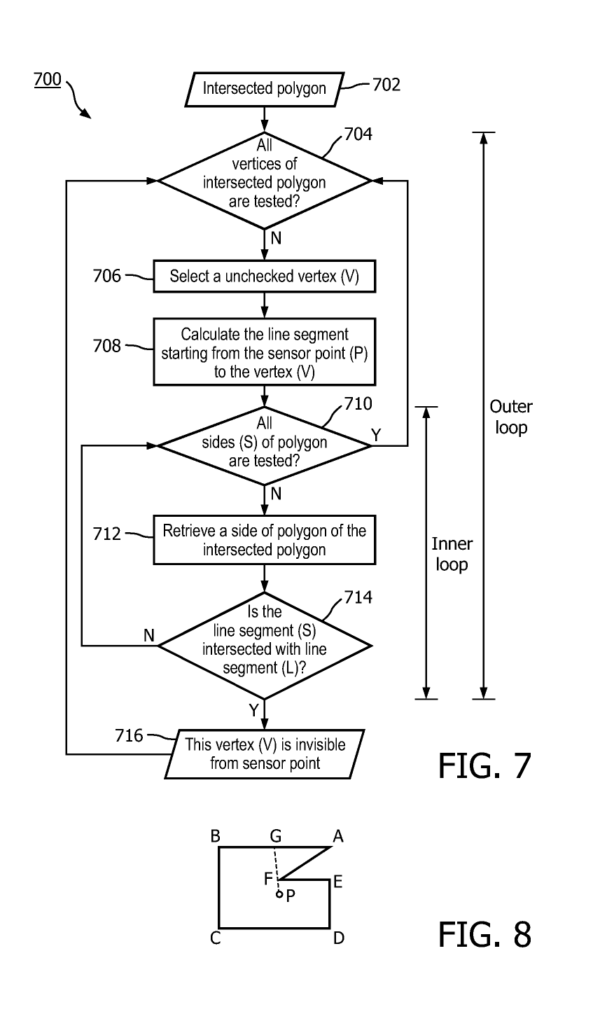

FIG. 7 shows a flow diagram that illustrates a process for testing the visibility of polygon vertices from a sensor used in FIG. 6, in accordance with embodiments of the present system;

FIG. 8 shows a diagram that illustrates an actual sensor coverage shape;

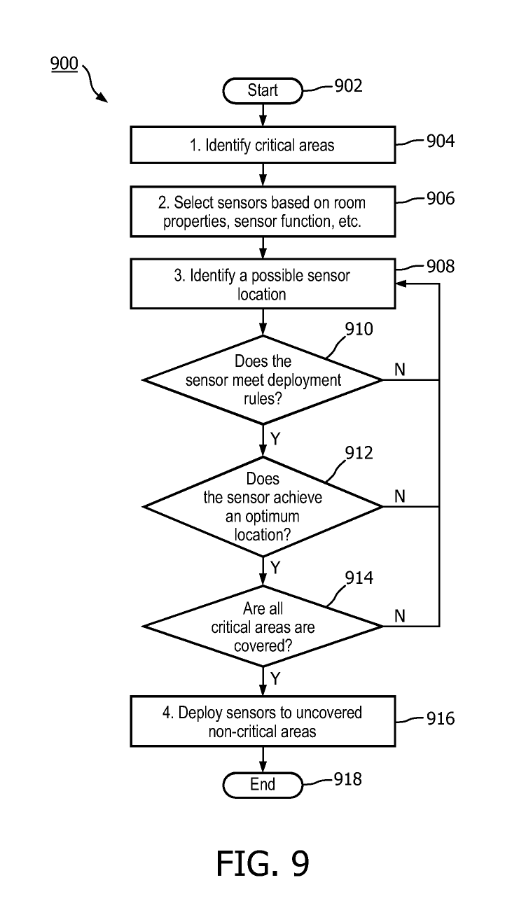

FIG. 9 shows a flow diagram that illustrates a process for an iterative method for sensor deployment in accordance with embodiments of the present system;

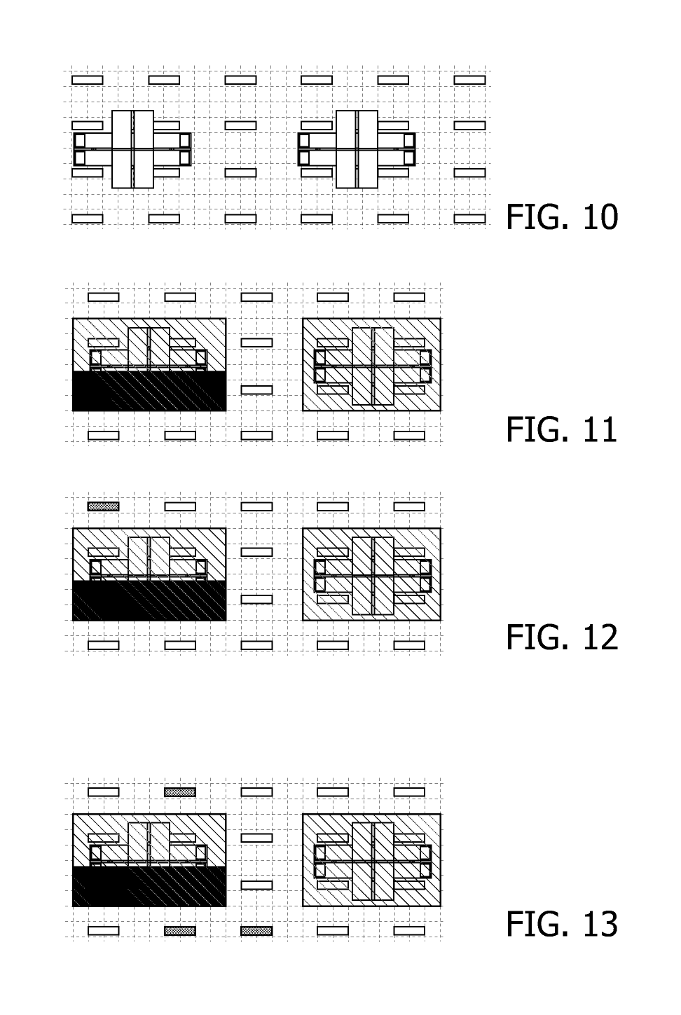

FIG. 10 shows a diagram that illustrates locations of workstation, ceiling and luminaire;

FIG. 11 shows a diagram that illustrates defined sensor coverage area of the workstations of FIG. 10;

FIG. 12 shows a diagram that illustrates identified luminaires relating to defined sensor coverage area of the workstations of FIG. 11.

FIG. 13 shows a diagram that illustrates critical areas of sensor coverage of the workstations of FIG. 10;

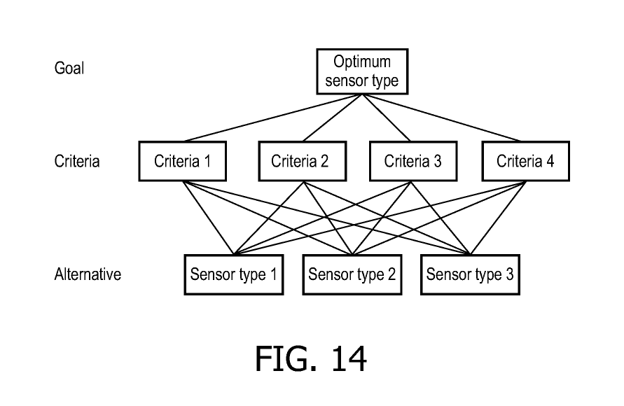

FIG. 14 shows a diagram that illustrates an analytic hierarchy process used in the process of FIG. 9;

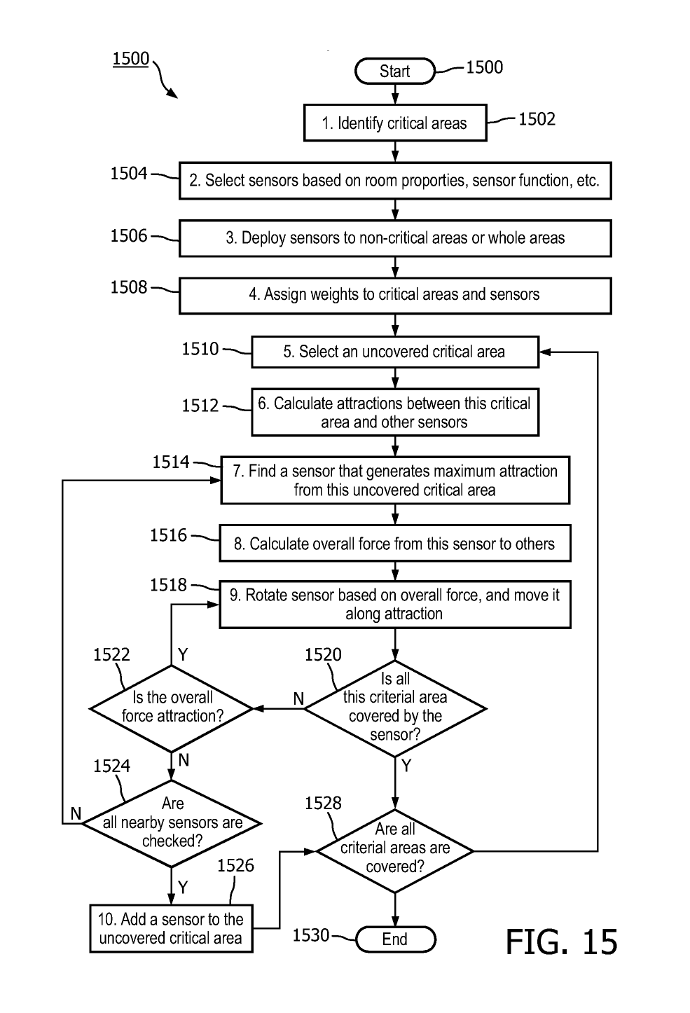

FIG. 15 shows a flow diagram that illustrates a process for a weight-based method for sensor deployment in accordance with embodiments of the present system;

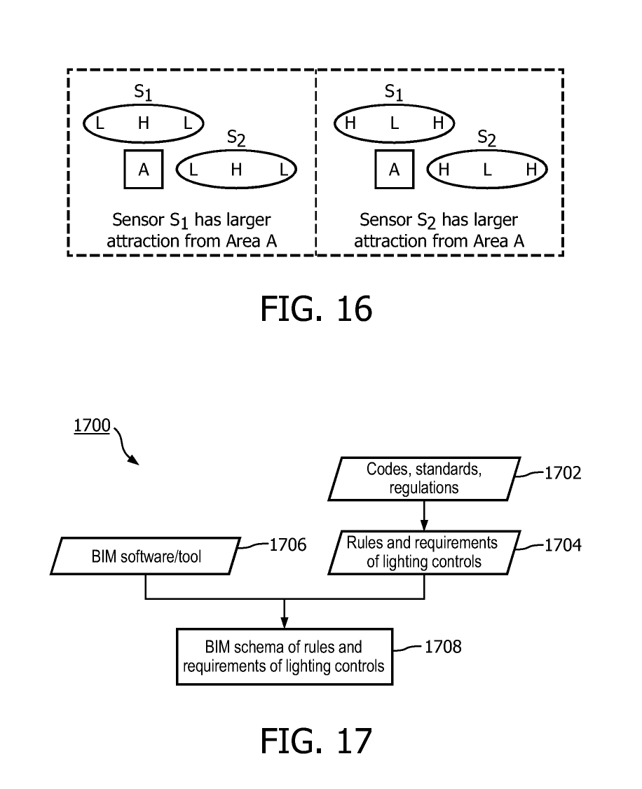

FIG. 16 shows a diagram that illustrates the impact of weight setting of the sensor deployment;

FIG. 17 shows a flow diagram that illustrates a process for creating BIM schema of rules and requirements of lighting controls in accordance with embodiments of the present system;

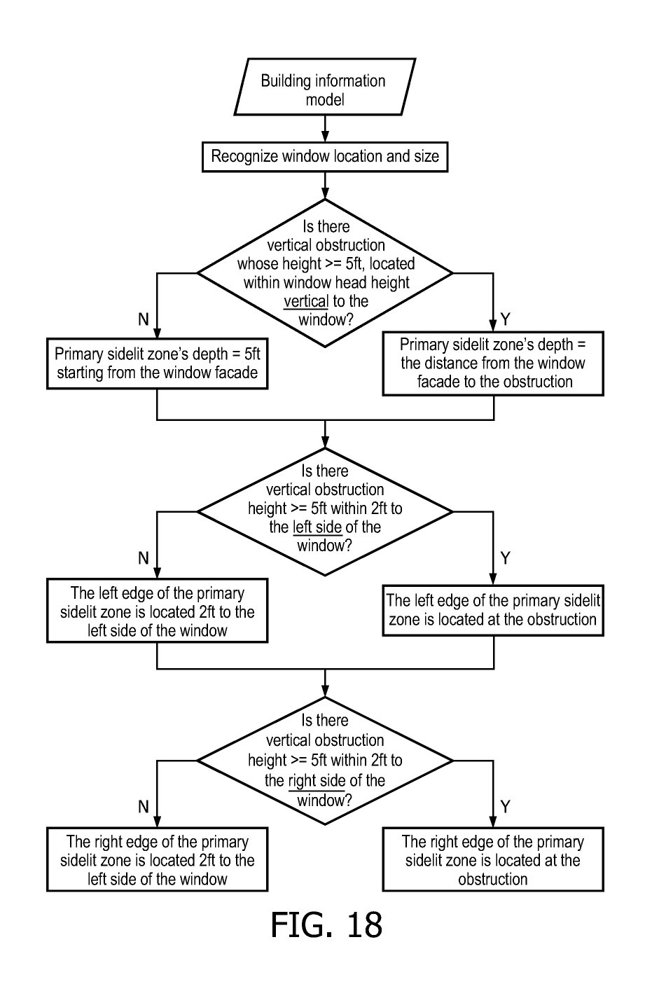

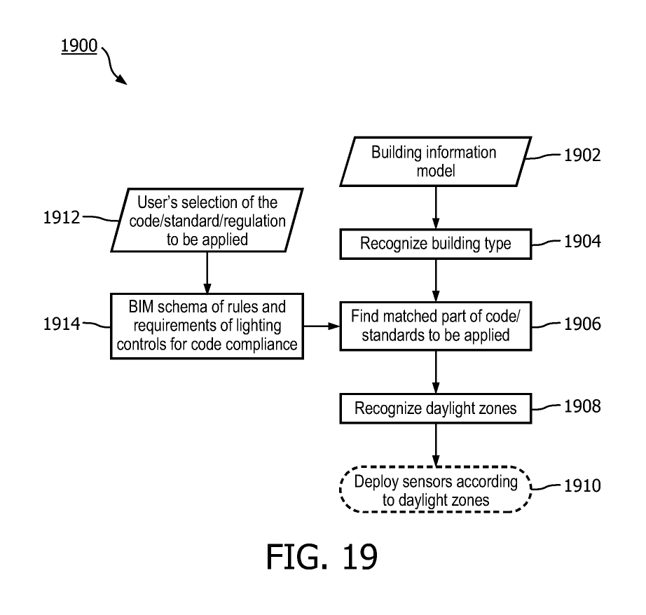

FIG. 18 shows a flow diagram that illustrates a schema of defining primary daylit zone based on CA Title 24;

FIG. 19 shows a flow diagram that illustrates a process for Automatic deployment of sensors according to the daylight zones defined in codes/standards/regulations in accordance with embodiments of the present system;

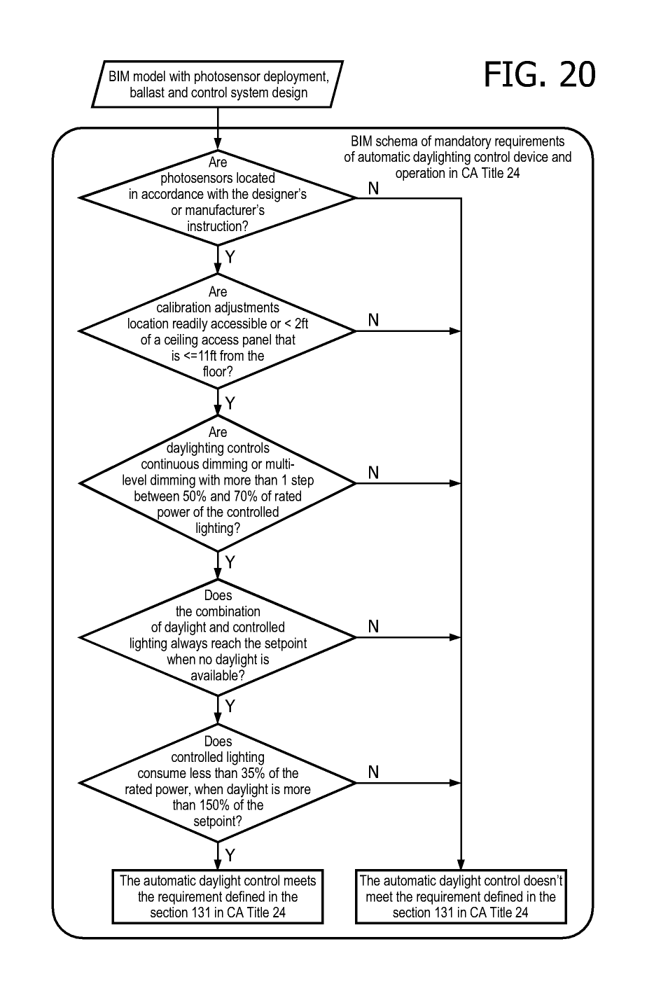

FIG. 20 shows a flow diagram that illustrates a process of code compliance checking in accordance with embodiments of the present system;

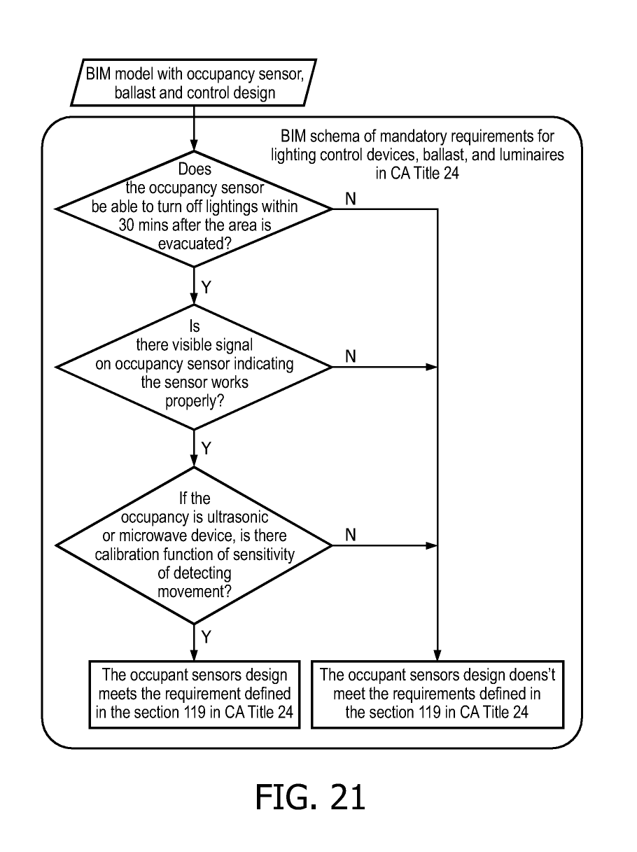

FIG. 21 shows a flow diagram that illustrates another process of code compliance checking in accordance with embodiments of the present system;

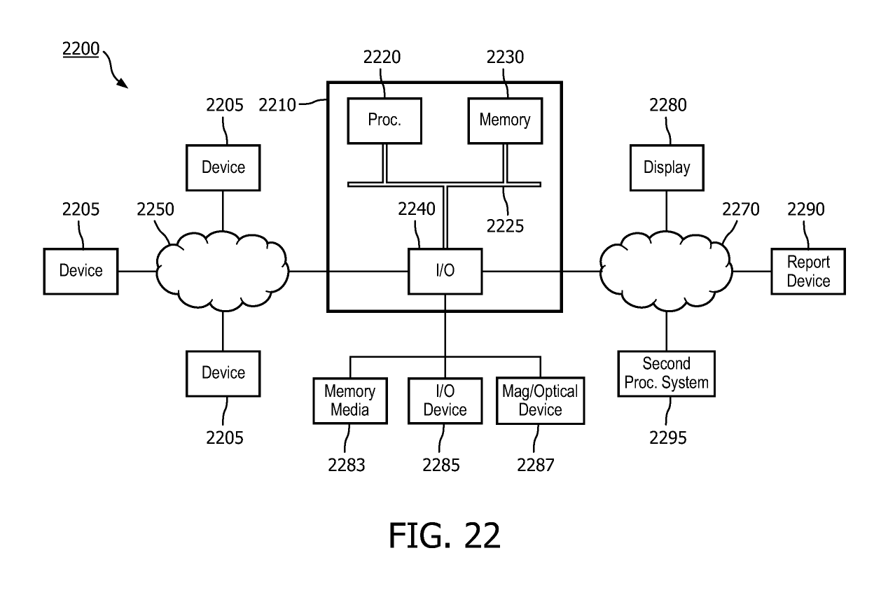

FIG. 22 illustrates a system in accordance with embodiments of the present system.

An exemplary process 100 of the first embodiment of sensor deployment is illustrated in FIG. 1. In step 102 the process is started in the system's processor (shown in FIG. 22) by an initialization. In step 104, the building information model is obtained. For example, loading a file containing building information model into process 100. In step 106, the sensor family information/file(s) are created, and they can be reused once created. In step 108, the sensor family information/files are sent to or loaded into the building information model. In step 110, the spatial element or geometry information 118 such as window, door, space boundary and HVAC vent position is retrieved from the building model. This information, together with the sensor information 120 obtained from steps 112, 114 and 116, will be used by the sensor location optimization process shown in step 122. In steps 112, 114 and 116, the space function is identified to define sensor types that are suitable for the identified space, and then all the sensor information is retrieved from chosen sensor model's family file. In step 122, the sensor location optimization process is called to obtain optimal sensor locations. In step 124, the deployment solutions such as optimized sensor location and sensor types are evaluated against compliance with code and user specified sensor performance requirements to determine whether the identified sensors and/or sensor locations satisfy or meet the sensing objectives for the space. In step 126, it is determined if the sensor type and locations complying with the code and performance requirements are found, if not, the process returns to step 114, if so, it is selected as shown in step 128. The process ends in step 130. The details of each step would be explained in this section.

Step 106: Creating Sensor Family Information/Files

As shown in FIG. 2, sensor family information/files are created based on the individual sensor's datasheet 202, sensor parameter definition file 206, and specific BIM software application data/information 204. The sensor datasheet is provided by manufacturer and contains details of sensor specifications. The sensor parameter definition file 208 defines parameters needed by the sensor family information/file 212. The parameters are generally defined by the sensor manufacturers, the specific parameter definitions (i.e., name and value) are either from manufactures' datasheet or other sources (e.g., BIM software Revit specifies some common parameters that all manufacturers should follow when they create the family files in Revit) This file defines parameter format such as sensor coverage area, sensor type, sensor position (ceiling or wall mounted), and so on (see Table 1). The sensor geometry model 210 is also created and used by the sensor family information/file 212. The sensor geometry model 120 is geometry of a 2D or 3D model (length, breath, height, radius, etc.) as shown, for example in a (BIM) building drawing.

TABLE 1
An example of sensor parameter definition file

| Group | Parameters | Values |
|---|---|---|
| Sensor | Manufacturer name | |
| manufacture | Sensor model | LRM1763 |
| Sensor cost | Cost | $95 |
| Sensor model | Image | .jpg file |
| geometry | Dimensions | Diameter = 88 mm |
| Sensor location | Room type | Open office/conference |
| | Host | Ceiling |
| | Constraint - Height | <4 m |
| | Constraint - window | Facing window |
| | Constraint - door | No |
| | Constraint - Air | Avoid |
| | terminal | |
| Motion-sensor | Coverage shape | Rectangle (.jpg file attached) |
| | Coverage dimensions | 5.4 m × 3.6 m (2.4 m ceiling |
| | | height) |
| | Coverage area | Ceiling_height\hat{ }2 * 3.375 |
| Photo-sensor | Coverage shape | Square (.jpg file attached) |
| | Coverage dimensions | 1.5 * ceiling_height |
| | Coverage area | ceiling_height\hat{ }2 |

The sensor family information/file 212 is contains specific information needed by that particular BIM software. For example, a family file in Autodesk Revit is “.rfa” format, which includes 3D geometry of sensors and parameter settings. FIG. 3 shows some parameter settings in a sensor family file in Autodesk Revit.

Step 108: Sensor Family Information/Files

Since sensor family information/files 212 can be software-dependent, the method of providing sensor family information/files 212 is also dependent on BIM device or software. FIG. 4 shows two approaches of providing sensor family information/files 212: manually and automatically loading. The BIM can provide a function of manually providing the BIM sensor family file 302. The BIM can also provide a BIM software API 304, through which the BIM software add-on or plugin 306 can automate the loading process. Either of these two approaches can then be used to provide the sensor family information/files 212, in step 308.

Step 110: Retrieve Spatial Geometry Information from Building Information Model

The spatial element (typically, the spatial element represents a room in a building model) is the unit in which context the sensor deployment method runs. A building model can be divided into a number of spatial elements (e.g., rooms). The geometry information of building elements located within the spatial element can be retrieved by this method.

The building information model contains geometry and materials information of building elements. These building elements affect placement of the sensors. The information retrieved includes but are not limited to:

Space 3D geometry: the space is bound by wall, ceiling, floor and interior furniture.

Space type: different space types (e.g. a conference room, a restroom, a corridor) may require different sensor models.

Window/door: window and door may affect photo-sensor position. For example, Philips OccuSwitch Wireless LRM1763 requires a minimum distance of 1.5 times of ceiling height from window.

Air terminal/vent: some sensors are temperature-sensitive and should not be placed near air terminal and vent.

Interior partition: some of interior partitions may affect the sensor coverage shape. For example, in the open office, the partition can block sensor visibility.

The specific approach of reading geometry information of the space depends on BIM software. Some BIM software provides API from which geometry information can be extracted. For example, Autodesk Revit API contains classes such as “Room”, “Wall” and “Ceiling”, from which the geometry information can be retrieved by the plugin.

The method may also be used for non-BIM based modelling software such as Autodesk AutoCAD because non-BIM based software also contains geometry information of the building. However, since not all information is included in the building model, the method may become limited and may need user to specify building elements such as HVAC vents and window position.

Step 112: Identifying the Function of the Space

The function of the space affects sensor model selection. For example, the function of a space may be identified as a conference room, a restroom, a corridor, office, etc. Each function requires different type of sensors fit for its needs. Several approaches can be used to identify the function of a space:

Room or space annotation: building model may include some annotation and tag of the space or room. For example, in Revit, the room tag may contain key words such as “conference”, “restroom”, or “bathroom”, from which the program can infer the function of the room.

Interior furniture: different space or room may have different furniture, which can be used to identify its function.

Geometry information: some geometry information such as room area and room shape can be used to estimate the function.

User-specified function: the user can also specify the function of the space manually

Step 114: Identifying a Potential Suitable Sensor Type/Model for the Space

For each space function, there will be some available sensor types/model. Some query will be developed to retrieve the available sensor type/models. Furthermore, the query can not only include retrieve space-specific sensor but also filter sensor based on other information listed in the parameter definition file. For example, assume all the sensor parameter definition files are stored in a database, thus an example of SQL query is used to select “conference” room type with cost less than 100 dollars and coverage area larger than 100 square feet.

SELECT sensor,

FROM table,

Where RoomType=“Conference” AND cost<100 AND coverage area>100.

Step 116: Retrieve Sensor Information from Family File

The family file defines all the sensor information needed by the sensor location optimization method (see Step 122). Because building design software has specific family file format. This step is to retrieve the information from sensor family file. The information retrieved is similar as information contained in the sensor parameter definition file (see FIG. 2).

Different software have different methods of retrieving the information. For example, Autodesk Revit can use API to retrieve this information. If the building design software does not have available API or the family file does not include all the necessary information, the sensor parameter definition file can be used to obtain the information.

Step 122: Running Sensor Location Optimization Methods

The sensor location optimization method has the ability of determining whether the (automatic) deployment of the sensors based on predefined or user-defined objectives (for example, minimizing the number of sensors, costs, maximizing system performance and/or no more than 10% of area is left uncovered etc.) is satisfied. Moreover, the output is the proposed optimal locations of sensors that meet criteria specified by the manufacturer such as avoid windows and vents.

Multiple Pareto optimal locations may be found. It is dependent on the preference of users to select optimal one. These sensors will be added into the building model automatically based on location information.

Depending on the sensor parameter definition files or sensor family files, different methods may be called according to the room geometry, runtime, and accuracy. Higher accuracy may require long computing time. Methods dealing with simple geometry (such as a rectangle room) are faster than the complex room geometry.

The sensor location optimization method considers at least the following three criteria:

Shape of sensor coverage area: square, circle, rectangle, ellipse or others.

Complexity of room geometry: some rooms have “L” or rectangular shape while others have holes in middle of the room.

Constraints of the sensor deployment: some sensor may have different requirements for the positions (e.g., only ceiling-based, or minimal distance from window).

Step 124: Evaluating the Performance of the Sensor Deployment

Sensors can be added into the building model via API. For example, the BIM Revit can provide a function “NewFamilyInstance( )” to enable a plugin to add family instance (e.g., sensors) to the building models automatically.

The performance of sensor deployment include: percentage of coverage, coverage area, number of sensor used, and sensor type, and code compliance and so on. The evaluation not only provides a summary of sensor deployment results but also allows designers to review the performance of sensor options and to compare different options. FIG. 5 shows a summary of sensor deployment results from which users can evaluate the deployment results. Then, the user may revise the parameters or change the design objectives.

Step 126/128: Selecting the Most Suitable Sensor Deployment Solution for the Space

The deployment of sensors is a multi-objective process, and the final selection also depends on the preference of designers as well as design objectives. By evaluation a number of sensor deployment solutions, the most suitable sensor deployment solution will be selected according to the criteria defined by the users with the aid of the method.

According to another aspect of the invention, the sensor location optimization method has the ability of automatically deploying sensors based on user-defined design objectives (minimizing the number of sensors, costs, maximizing system performance and/or no more than 10% of area is left uncovered etc). The output is the proposed optimal locations of sensors that meet criteria specified by the manufacturer such as avoid windows and vents.

Multiple Pareto optimal locations may be found. It is dependent on the preference of users to select optimal one. For example, runtime of the method depends on the complexity of the space boundary and shape. Computation time for simple geometry (such as a rectangular space) is faster than complex shape.

FIG. 6 shows the process of the sensor location optimization method 600 in the system's processor (shown in FIG. 22). The details of each step would be explained below.

Step 602: Space Geometry and Sensor Information

This step is to retrieve space and sensor geometry information from building models. The information can be simply text-based, or integrated with family files of building design software (e.g., Autodesk Revit). The space geometry is represented as polygons, which uses vertices and the corresponding vertex direction. The information may include:

Space or room boundary polygons;

Spatial element (e.g., window, door and HVAC) positions;

Sensor coverage shape and coverage area;

Sensor deployment constraints (e.g., minimum distance from window, avoiding HVAC vents).

Step 604: Sensing Objectives/Parameter Settings (from Users)

Some sensing objectives or sensor parameter settings should be specified by users according to design objective of sensors.

Maximum percentage of the uncovered area: the method uses a heuristic method to calculate sensor positions, and thus this parameter is used as a threshold for determine when the method should stop.

Design objectives: the objectives include (a) maximizing the system performance or maximizing the covered area; (b) minimizing the number of sensors.

Step 606: Deploy Sensors Uniformly in the Rectangular Bounding Box

The space boundary can be represented as polygons. It is easy to deploy sensors in a rectangle uniformly by dividing the rectangle length or width by sensor's dimensions. For other non-rectangular shapes, the rectangular bounding box is calculated first so that initial sensor positions can be uniformly distributed within the rectangular bounding surface without considering the specific shape of polygons and other constraints. In step 608, each possible sensor position will be checked to ensure no violation of sensor parameters, e.g. sensor deployment constraints. The specific steps include:

Firstly, calculate the rectangular bounding box of the polygon.

Secondly, deploy sensors uniformly within the bounding rectangle. If the actual space boundary is not rectangular, some sensors will fall outside of the space boundary. For example, assume the size of a rectangular bounding box is 10 ft×20 ft, and a sensor has a rectangular coverage with dimensions of 5 ft×5 ft. This method will assign sensors in the boundary rectangle evenly with 2×4 sensors along each of its sides.

Step 610: Check Polygon and Sensor Deployment Constraints

Not all the sensor positions obtained from step 606 are valid if sensors are uniformly deployed within the boundary rectangle. Two types of constraints should be checked in this step:

Polygon constraints: These constraints are generated by the polygon shape. For example, assume there is a polygon representing a space with “L” shape. Since the bounding box is rectangular, after sensors are deployed in the space, some sensors would fall outside of the polygon. A ray-casting method can be used to test whether a sensor position is located within the polygon or not.

Sensor deployment constraints: Sensors cannot be arbitrarily located anywhere within the space even if the polygon constraint is met. For example, some sensors maintain a minimum distance from window or door while others cannot be placed near air terminal. Each sensor point would be checked to ensure no violation of these constraints.

In step 612, if it is not a valid position the method moves to step 614, if so, to step 608.

Step 614: Remove the Sensor Position

If any sensor position violates the polygon constraint or sensor deployment constraint, the position should be marked as “invalid”, and be removed from the list of potential sensor positions. As shown in FIG. 6, all the possible sensor positions calculated in step 604 will be checked.

Step 616: Extract Uncovered Polygons by Subtracting the Covered Areas from the Whole Polygon Area

The remaining possible sensor positions are valid after step 610. Removing invalid sensor positions in step 610 may cause some areas uncovered. Therefore, we proposed a method that can be used to calculate uncovered polygons. Note that the polygon operations such as intersection, union and difference shown in this step can use existing polygon clipping methods (e.g., Vatti's clipping method).

Firstly, a possible sensor location is obtained from previous steps. Since there may exist walls or interior partitions blocking the sensor coverage area, the actual coverage shape may not the same as the sensor coverage shape defined in the datasheet. Therefore, a method to calculate the actual sensor coverage shape is shown in FIG. 7.

The method 700 shown in FIG. 7 is to connect the sensor point (P) to each vertex (V) of the polygon to formulate a line segment (L), in step 708, and then test whether this line segment L is intersected with any side of the polygon, in step 714. If there is any intersection, the vertex V is not seen from sensor, in step 716.

There are two loops as shown in FIG. 7: inner and outer loops. The process begins with the Intersected polygons in step 702. In step 704 it is determined if all vertices of intersected polygons have been tested. For the outer loop, in step 706 each unchecked vertex V of the polygon selected, and checked to ensure the vertex is visible from the sensor position (steps 708, 710, 712, and 714). For inner loop, check whether each side (S) of the polygon is intersected with the line segment L (steps 710, 712, 714). If it is interested, the vertex V is not visible from the sensor, step 716.

After determining which vertices are visible from the sensor point, calculate the union of all the covered polygons, and then subtract the union area from the whole polygon area to obtain the remaining uncovered area.

When a vertex of a polygon side is visible from sensor and another vertex is not visible according to the method shown in FIG. 7, there exists a cut-off point in between so that one segment is visible from sensor and the other segment is not visible (assuming no hole exists in the polygon). This is illustrated in FIG. 8. For the polygon side AB, the vertex A is not visible from sensor point P. In this case, this cut-off point (i.e., the vertex G in FIG. 8) can be determined by calculating the intersection point between this polygon side AB and the half-line (e.g., line PF) starting from the sensor position to a polygon vertex.

In step 618, it is determined if the remaining polygon is a rectangle or near-rectangle. If so, the process proceeds to step 622, if not to step 620.

Step 620: Use Greedy or Heuristic Method to Optimize Sensor Locations

A greedy or heuristic method is used when the uncovered polygon is not rectangular or shows complex shape. For example, a possible greedy method is described as follows: in each iteration, a sensor position is found to maximize the coverage area. Once this sensor position is found, subtract the covered area from the whole polygon. Repeat this process until the threshold is reached.

In step 622, it is determined if the remaining uncovered area is below a threshold. If so, the process proceeds to step 624, if not to step 606.

Step 624: Calculate the Total Area

This step is to calculate the total covered area of sensors. The method used in this step is the same as the method shown in Step 616 because the actual sensor coverage shape may not be the same as that specified in the datasheet. The union of all the sensor covered area is achieved by polygon union operation.

This invention can be used for software and tools for automatic sensor deployment. This invention can be integrated with Philips sensor product (e.g., Philips OccuSwitch sensor, Dynalite sensor) so that this method can be implemented in the building information modelling software and allows users to explore Philips sensors for their design.

According to another aspect of the invention, a critical area is defined as an area that a sensor should cover in order to provide good performance. The critical area may include where the desk or cubicles in open plan office is located. This includes optimizing current sensor deployment methods by adding the capabilities of covering preferred areas. The method includes: prioritizing the sensor deployment workflow; optimizing optimum sensor locations by evaluating interior space layout information; and providing coverage of sensors in preferred areas. In this regard, two methods are proposed: in FIG. 9, the iterative method; and FIG. 15, the weight-based method. The processes of the two methods are described below.

Iterative Method

In FIG. 9, the system's processor (shown in FIG. 22) begins the process 900 in step 902. The method iterates each possible sensor location while considering the deployment rules, and select sensor positions that could achieve the optimum conditions. Then, use sensor deployment method to deploy sensors in other area.

Step 904: Identify Critical Areas

The example of some critical areas includes cubicle area and workspace areas, or any other areas that a user defines. The way of defining the critical areas is to use polygon representation or use points to represent the critical areas. The identification of the critical areas needs to consider:

furniture, workstation, cubicles, partitions etc.

luminaire locations

ceiling grid pattern

An example (see FIG. 10) is used to illustrate the steps of identifying critical areas.

Include furniture, workstation, and luminaire locations in a drawing. FIG. 10 shows the reflected ceiling plan, luminaire locations and workstation geometry.

Define areas that covered important elements (e.g., workstation, furniture) (see FIG. 11).

Identify luminaires that are used to provide light to those areas defined in Step 2), and identify the coverage of luminaires (see FIG. 12)

Calculate the intersection of the areas defined in Steps 2) and 3). The critical areas are shown in FIG. 13.

Step 906: Select Sensors Based on Room Properties, Sensor Function, Etc.

Selecting sensors from a portfolio of sensors is based on room size, room function, sensor function, sensor coverage shape, etc. We propose a two-step sensor selection process. The first step is to identify an initial set of sensor types based on general criteria. The second step is to refine the selection according to sensor deployment goals and sensor functions.

Initial Filtering

This step is to provide a quick filter to identify sensor types based on the given room property. One way is to add room property tag to sensors. The tag stores basic room property information such as room type (e.g., conference room, bathroom), room size, and room area that a sensor is best suitable for.

Optimized Selection

This step is to optimize sensor selection given the selected set of sensor types. The input would be the set of sensor types and room information (e.g., geometry, workstation location, ceiling grid, etc.). A designer should address two types of questions:

Question related to deployment goals: What is your sensor deployment goal: minimizing sensor cost, maximizing sensor performance, or in-between? Is there any available sensor type that meets your needs? What decision-making techniques do you use?

Questions related to sensor functions: Which one meets your deployment goals: wall or ceiling mounted for this room? Which type meets your deployment goals: photo sensors, or occupancy sensors, or both? How does the lighting control affect sensor deployment? Is the sensor integrated with the luminaire? What is the impact of the daylight availability on sensor performance?

After addressing the above question, the next step is to further filter out unsuitable sensor types based on the sensor function and their ability of meeting the deployment goals.

Then the next step is to define the criteria of evaluate the sensor selection, for instance, reducing sensor cost, utilizing daylight harvest.

The last step is to select the optimum sensor type using multiple-objective (or single objective) decision-making technique. For example, FIG. 14 illustrates an example of using AHP (analytic hierarchy process) to select sensors.

Step 908: Identify a Possible Sensor Location

After the sensor is selected, a possible sensor location should be identified by using optimization methods, which should consider at least two criteria:

Deployment objectives: the objectives include: minimizing sensor count, or reducing sensor costs, or maximizing sensor performance (e.g., maximizing sensor coverage of preferred area).

Deployment rules: The manufacturers' rules (e.g., rules stated in datasheet) and other code standard compliance should be checked to valid sensor deployment positions. Some examples of rules include: do not place the sensor close to heat sources or HVAC exhausts; do not place the sensors near the window; do not Install sensors where the line of sight is blocked by partitions; do not install sensors so that their line of sight continues beyond doorways; compliance with building design code requirement.

In steps 910, 912, 914, it is determined if the sensors meet the deployment rules, achieve an optimum location and if all critical areas are covered. If not the process returns to step 908, if so it proceeds to step 916.

Step 916: Deploy Sensors to Uncovered Non-Critical Areas

Since some critical areas have already been covered by sensors as shown in step 906, sensors should be deployed into the non-critical area. Note that the deployment of sensors should follow the constraints of deployment rules. The specific sensor deployment methods can be manual or automatically. Some of the existing sensor deployment methods may be adapted to lighting sensor deployment. The sensor deployment should consider the coverage shape of sensors.

The process ends in step 918.

Weight-Based Method

In FIG. 15, the system's 1500 processor (shown in FIG. 22) and steps 1502 and 1504 are the same as steps 904 and 906 of the iterative method of FIG. 9. Step 1506 is similar to Step 916 in FIG. 9 except that sensors can be deployed in non-critical areas or the whole area.

Step 1508: Assign Weight to Critical Areas and Sensors

The weight here resembles the weight of an object. Higher weight will have high attractive or repulsive force between two objects. The weights of critical areas and sensors are assigned by users. The attraction exists between sensors and critical areas, and repulsion exists between sensor objects. The weight of an object is determined by users. For example, difference areas of sensor coverage can be set to different weight. For example, in FIG. 16, the weight may have different impact on the attractive forces from the sensor to the critical area. In the left side, the sensor S₁ may have more attraction because the middle part (higher weight) of the sensor coverage has high attraction than other two sides. In the right side figure, the two end parts show higher weight and may show higher attraction to the area A.

Step 1510: Select an Uncovered Critical Area

If an uncovered critical area exists, this area is selected in this step.

Step 1512: Calculate Attractions Between this Critical Area and Another Area

The attraction (or gravitation) calculation is a function of weight and distance of sensor and critical areas. Various formulas can be created. An example formula is: G=αw₁w₂/r^{β}, where α and β are coefficients assigned by users; w₁=weight of a critical area; and w₁=weight of a sensor. Similarly, we can formulate some other formulas to calculate the repulsive forces between sensors and sensors. Note attraction or repulsion should only exist within a specific range because of blocking by other sensors would reduce the force multitude.

When sensor coverage intersects with a critical area, the weight of the intersection area becomes zero, and thus no attraction exists between the intersection area and other critical areas or sensor.

Step 1514: Find a Sensor that Generates Maximum Attraction from this Uncovered Critical Area

For the selected critical area, the attraction between this critical area and other sensors (i.e., sensors within specified range) are calculated. The sensors causing maximum attraction is selected.

Step 1516: Calculate Overall Force from this Sensor to Others

For the selected sensor in step 1512, the overall force is calculated. The overall force includes attractive force from critical area and repulsive forces from other sensors.

The overall attractive force from all critical area to this sensor is calculated based on the formulas. Since the force is a vector and the overall attraction is summation of the vectors. The direction of the attractive force directs the movement direction of sensors toward the critical area.

The overall repulsive force from nearby sensors is calculated. This force is used to rotate the sensors to reduce the overlapping between sensors, and is also used to judge whether the sensor should be moved toward the critical area or not.

Step 1518: Rotate Sensor Based on Overall Force and Move it Along Attraction

This step includes two actions: rotation and movement:

Shift, rotate or move the sensor so that the main axis of sensors is perpendicular to the overall force before actual movement.

Move the sensors along the direction of attraction between this sensor and the specified critical area. During process of the movement, the deployment rules (e.g., from datasheet, code, or standard) are checked to ensure no violations occur. Once a violation is detected, this current sensor location is marked as invalid, and the next sensor location is checked.

After movement of this sensor, there may be three possible conditions as shown in steps 1520, 1522, and 1524.

In step 1520, if the current critical area is covered by this sensor, then this critical area is finished and as non-critical area, and the next critical area is checked.

In step 1522, if the current critical area is not completely covered by this sensor, then recalculate the overall force of the sensor. If the overall force of this sensor is still toward the critical area (i.e., not repulsive force toward the critical area), then repeat this step (rotation and movement).

In step 1524, if the current critical area is not completely covered by this sensor, and after recalculation, it is found that the overall attraction is toward opposite direction (i.e., repulsive force for the critical area), then another nearby sensor is selected to repeat this step.

Step 1526/1528: Add a Sensor to the Uncovered Critical Area

It is possible that after movement of all nearby sensors, there still exist uncovered sensor areas, in step 1528 it is determined if all critical areas have been covered. Then, in step 1526, a new sensor will need to be added into the uncovered critical area. Repeat the process from step 1510, if needed.

According to another aspect of the invention, the invention includes a method for building code compliance using the building information model software by: creating BIM schema of rules and requirements based on codes/standards/regulations in BIM software; creating device and controller family with parameters and information that is related to code compliance; and instructing and supporting lighting control system design to meet codes/standards/regulations requirement including: automatically selecting devices or products; automatically deploying devices or products in the BIM; and assessing code compliance for lighting control design.

FIG. 17 shows the method building code compliance. In step 1702, the system's 1700 processor (shown in FIG. 22) receives codes, standard, regulations relating to a set of devices (e.g. lighting devices) in a building or other predefined space. In step 1704, the rules and requirement of the, for example, lighting devices and controls are determined. In step 1706, the BIM software/tool to be used is determined and there application data/requirements for its use is also determined. In step 1708, a set of rules is determined that enable the use of the rules and requirements of the devices (e.g. lighting devices and controls) in the BIM. As those skilled in the art will understand, for example, a BIM schema of rules and requirements for the devices is developed. This set of rules is then used to enable deployment the devices in the building or other predefined space, according the BIM specifications. For example, a device deployment plan via the BIM is provided.

FIG. 18 is an example of BIM schema for California Title 24 section 131 (c) that defines the daylight area. Daylight area, primary sidelit is the combined primary sidelit area without double counting overlapping areas. The floor area for each primary sidelit area is directly adjacent to vertical glazing below the ceiling with an area equal to the product of the sidelit width and the primary sidelit depth. The primary sidelit width is the width of the window plus, on each side, the smallest of: 2 feet; or the distance to any 5 feet or higher permanent vertical obstruction.

The primary sidelit depth is the horizontal distance perpendicular to the glazing, which is the smaller of: one window head height; or the distance to any 5 feet or higher permanent vertical obstruction.

The parameters and performance description related to code compliance shall be embedded in device's BIM model, for example, the family file in Revit software. Besides the 3D geometry information, the following 4 categories shall also be included in family model: general information, performance data, energy consumption, and installation instructions.

Here is an example of a BIM model for a photosensor:

General information: Manufacture name, Sensor model, Cost

Performance data: Coverage shape, Coverage dimensions, Coverage area (major/minor), Sensitivity

Electrical information & energy consumption: Voltage, Amp, Power

Installation requirements: Distance from the window, Distance from ceiling vent, Wiring requirement

The second part is to instruct or automate lighting control system design to meet codes/standards/regulations' requirements. FIG. 19 is one example of instructing photosensor deployment with the code compliance schema. After daylight zoning has been defined with the method in FIG. 18, a BIM based automatic sensor placement method, described above, can deploy sensors within the daylight zone.

FIG. 19 illustrates the method 1900 of auto deployment of sensors within the daylight zone. In step 1902, the method begins with the particular BIM. In step 1904, the building types are recognized. In steps 1912 and 1914, the user selects the code/standard/regulations to be applied and the BIM schema of the rules and requirements of the lighting controls for code compliance is generated. In step 1906, it finds matched parts of the code/standards to be applied. In step 1908, it recognizes the daylight zones. In step 1910, the sensors are deployed according to the daylight zones.

The third part is automatic checking how the system design satisfies/meets the requirements in the codes/standards/regulations.

FIG. 20 is an example of checking whether sensor deployment satisfies the daylighting control devices installation and operation requirements defined in CA Title 24 section 131.

FIG. 21 is another example of checking how occupancy sensor design is in compliance with CA title 24 section 119 which are mandatory requirements for lighting control devices, ballasts, and luminaires.

FIG. 22 illustrates a system 2200 for implementing the principles of the invention as depicted in the exemplary processing system shown herein. In this exemplary system embodiment 2200, input data is received from sources 2205 over network 2250 and is processed in accordance with one or more programs, either software or firmware, executed by processing system 710. The results of processing system 710 may then be transmitted over network 2270 for viewing on display 2280, reporting device 2290 and/or a second processing system 2295.

Processing system 2210 includes one or more input/output devices 2240 that receive data from the illustrated sources or devices 2205 over network 2250. The received data is then applied to processor 2220, which is in communication with input/output device 2240 and memory 2230. Input/output devices 2240, processor 2220 and memory 2230 may communicate over a communication medium 2225. Communication medium 2225 may represent a communication network, e.g., ISA, PCI, PCMCIA bus, one or more internal connections of a circuit, circuit card or other device, as well as portions and combinations of these and other communication media.

Processing system 2210 and/or processor 2220 may be representative of a handheld calculator, special purpose or general purpose processing system, desktop computer, laptop computer, palm computer, or personal digital assistant (PDA) device, smart phone etc., as well as portions or combinations of these and other devices that can perform the operations illustrated.

Processor 2220 may be a central processing unit (CPU) or dedicated hardware/software, such as a PAL, ASIC, FGPA, distributed architecture, cloud based, etc., operable to execute computer instruction code or a combination of code and logical operations. In one embodiment, processor 2220 may include code which, when executed by the processor, performs the operations illustrated herein. The code may be contained in memory 2230, may be read or downloaded from a memory medium such as a CD-ROM, floppy disk, hard-drive and the like, represented as 2283, may be provided by a manual input device 2285, such as a keyboard or a keypad entry, or may be read from a magnetic or optical medium (not shown) or via a second I/O device 2287 when needed. Information items provided by devices 2283, 2285, 2287 may be accessible to processor 720 through input/output device 2240, as shown. Further, the data received by input/output device 2240 may be immediately accessible by processor 2220 or may be stored in memory 2230. Processor 2220 may further provide the results of the processing to display 2280, recording device 2290 or a second processing unit 2295.

As one skilled in the art would recognize, the terms processor, processing system, computer or computer system may represent one or more processing units in communication with one or more memory units and other devices, e.g., peripherals, connected electronically to and communicating with the at least one processing unit. Furthermore, the devices illustrated may be electronically connected to the one or more processing units via internal busses, e.g., serial, parallel, ISA bus, microchannel bus, PCI bus, PCMCIA bus, USB, etc., or one or more internal connections of a circuit, circuit card or other device, as well as portions and combinations of these and other communication media, or an external network, e.g., the Internet and Intranet. In other embodiments, hardware circuitry may be used in place of, or in combination with, software instructions to implement the invention. For example, the elements illustrated herein may also be implemented as discrete hardware elements or may be integrated into a single unit.

As would be understood, the operations illustrated may be performed sequentially or in parallel using different processors to determine specific values. Processing system 2210 may also be in two-way communication with each of the sources 705. Processing system 2210 may further receive or transmit data over one or more network connections from a server or servers over, e.g., a global computer communications network such as the Internet, Intranet, a wide area network (WAN), a metropolitan area network (MAN), a local area network (LAN), a terrestrial broadcast system, a cable network, a satellite network, a wireless network, or a telephone network (POTS), as well as portions or combinations of these and other types of networks. As will be appreciated, networks 2250 and 2270 may also be internal networks or one or more internal connections of a circuit, circuit card or other device, as well as portions and combinations of these and other communication media or an external network, e.g., the Internet and Intranet.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as only one of or “exactly one of,” or, when used in the claims, “consisting of,” will refer to the inclusion of exactly one element of a number or list of elements. In general, the term “or” as used herein shall only be interpreted as indicating exclusive alternatives (i.e. one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of patent Examining Procedures, Section 2111.03.

1) A method for deploying sensors in a predefined space, wherein the method uses a building information model (BIM), the method comprising steps of:
in a processor,
receiving, from the BIM, geometry information of a space which relates to a sensing coverage area of the space and sensor information;
creating a plurality of BIM sensor family information, wherein each sensor family information defining at least two or more parameters of a respective sensor including at least two of, sensor coverage area, sensor type, sensor position, manufacture, cost, sensor model geometry, and information relating to the BIM;
transmitting the plurality of BIM sensor family information to the BIM;
receiving spatial geometry information including elements within the space from the BIM;
identifying a room type or at least one function of the space using the spatial geometry information from the BIM, including at least one of room or space annotation, interior room or space furniture layout, room or space geometry, wherein the function of the space is used to identify a sensor from the plurality of BIM sensor family information;
determining a sensor location in the space for the identified sensor using the sensor family information and spatial geometry information,
evaluating whether the identified sensor and/or sensor location for the space satisfies a sensing objective.

2) The method of claim 1, wherein one of the parameters in sensor family information is a placement rule for a sensor, as defined by a sensor manufacture, and step of determining the sensor location includes computing a sensor coverage area of the identified sensor based on the placement rule.

3) The method of claim 1, wherein the step of receiving the spatial geometry information includes dividing the space into spatial elements and each spatial element including at least one element and wherein the space is a building, and the spatial element is a room, and the element is one of a window, door, air terminal, vent, luminaire and interior partition.

4) The method of claim 1, wherein the creating sensor family information step uses the sensor datasheet, defined sensor parameters and BIM application data.

5) The method of claim 1, wherein the function is one of a conference room, a restroom, a corridor, a utility area, a warehouse and an office.

6) The method of claim 1, wherein the sensing objective is compliance with a code or a specified sensor performance requirement or minimizing the number of sensors, or minimizing costs.

7) A method for deploying sensors in a predefined space the method comprising steps of:
in a processor,
(1) receiving geometry information of a space which relates to a sensing area of the space and sensor information;
(2) receiving sensing objectives which define at least one of maximum percentage of the uncovered area, maximizing a system performance, minimizing the number of sensors;
(3) representing the sensing area of the space using a polygon and a rectangular bounding space to determine initial sensor positions that are distributed uniformly within the rectangular bounding space using the sensor information;
(4) determining whether the initial sensor positions satisfy a sensor parameter from the sensor information and if any of the initial sensor positions are outside the polygon;
(5) removing a sensor position outside the polygon or violating the sensor parameter;
(6) removing uncovered sensing area by the removed sensor position from the polygon;
(7) if a remaining polygon after removing the uncovered sensing area is not substantially a rectangle then use a greedy method to optimize the sensor locations;
(8) determine if the remaining polygon is below a threshold, if not repeat steps (3)-(7).

8) The method of claim 7, wherein the optimization method includes satisfying one or more predetermine criteria, wherein the criteria include one of minimizing total number of sensors deployed and minimizing total cost of sensor deployed.

9) The method of claim 7, wherein the sensing objectives are one or more of maximizing the covered area and minimizing the number of sensors to be deployed.

10) The method of claim 7, further including the step of depicting sensor locations on a display, including a floor plan and coverage area of each sensor, wherein the coverage area is bounded spatial elements of the space.

11) A method for deploying sensors in a predefined space the method comprising steps of:
in a processor,
receiving sensing objectives;
receiving geometry information of a space which relates to a sensing coverage area of the space and sensor information;
identifying a critical area of the space to be covered by sensing areas of sensors;
selecting initial sensors based on of the geometry information, sensor information and sensing objectives;
determine initial sensor locations based on sensor information and sensing objectives;
determine whether initial sensors and initial sensor locations satisfy deployment information received from the sensor information and sensing objectives, and if the critical areas are covered by sensing areas of sensors, if not return to the determine sensor location step.

12) The method of claim 11, wherein the critical areas include one or more of, furniture, workstation, cubicles, partitions, luminaire locations and ceiling grid pattern.

13) A method for deploying sensors in a predefined space the method comprising steps of:
in a processor,
receiving sensing objectives;
receiving geometry information of a space which relates to a sensing coverage area of the space and sensor information;
identifying critical area of the space to be covered by sensing areas of the sensors;
select sensors based on of the geometry information, sensor information and sensing objectives;
determine sensor locations;
assign a weight to critical areas and/or sensors, wherein an attraction exists between sensors and critical areas and a repulsion exists between sensor objects;
determine sensors with maximum attractions between a critical area and another area;
determine a force of the maximum attraction sensor to other sensor which includes an attractive force from the critical area and repulsive forces from other sensors;
move/rotate the maximum attraction sensor to determine if the deployment information is satisfied and if the critical area is covered by this sensor, if not re-determine the force, and/or determine whether another sensor is added.

14) A method for determining compliance with code/regulations relating to one or devices in a predefined space, wherein the method uses a building information model (BIM), the method comprising steps of:
in a processor,
receiving codes/regulations related to the devices;
determine rules/requirements of the device parameters using the received codes/regulations for use in the space; and
determine rules for the BIM using the device parameter rules/requirements and application data/requirements of the BIM to enable a deployment of the devices in the predefined space.

15) The method of claim 14, wherein a user selects the codes/regulations related to the devices.

16) (canceled)
